(19) United States
(12) Patent Application Publication
(10) Pub. No.: US 2012/0137700 A1
(43) Pub. Date: Jun. 7, 2012

(54) System for Producing Power Using Low Pressure Gasification of a Stock Fuel

(76) Inventors: Dennis John Werner, Houston, TX (US); Thomas Edwin Hogan, Dallas, TX (US)

(21) Appl. No.: 13/308,765

(22) Filed: Dec. 1, 2011

Related U.S. Application Data
(60) Provisional application No. 61/420,593, filed on Dec. 7, 2010.
(60) Provisional application No. 61/420,595, filed on Dec. 7, 2010.
(60) Provisional application No. 61/420,606, filed on Dec. 7, 2010.
(60) Provisional application No. 61/420,617, filed on Dec. 7, 2010.

(51) Int. Cl. F02C 3/28

(52) U.S. Cl. 60/781; 60/39.12

(57) ABSTRACT

A system for power generation using low pressure gasification of a stock fuel, such as coal or biomass. The system can include a gasifier, a gas clean up unit connected to a gas compressor, a gas turbine combustion system, a heat recovery steam generator, and a steam turbine. The gasifier can provide low pressure synthetic methane gas to the gas clean up unit, which can remove tars and sulfur from the synthetic methane gas, and can cool the synthetic methane gas. The gas compressor can receive the cooled synthetic methane gas and can compress the cooled synthetic methane gas. The gas turbine combustion system can receive the compressed synthetic methane gas and produce power and an exhaust gas. The heat recovery steam generator can receive the exhaust gas and generate steam. The steam turbine can receive the steam from the heat recovery steam generator and generate power.

### RELATED APPLICATIONS

This application claims priority to U.S. Provisional Applications Ser. Nos. 61/420,593; 61/420,595; 61/420,606; and 61/420,617, the entire texts of which are specifically incorporated herein by reference without disclaimer.

### FIELD

The present embodiments generally relate to systems and methods for power generation using low pressure gasification of a stock fuel, such as biomass or coal.

### BACKGROUND

The United States has the largest coal reserves in the world. Coal can be used to generate electric power. In some power generation plants, gasifiers are used to turn the coal into gas before the coal is burned. Gasification is a process of converting carbon-based materials, such as coal or biomass, into gases such as carbon monoxide, hydrogen, carbon dioxide and methane. The resultant gases can then be used as fuel.

Gasification enables power generators to utilize coal cleaner than natural gas because particulates, such as sulfur and mercury, can be removed before combustion. This “green technology” may help make coal a clean energy source, thereby adding thousands of “green” energy jobs in the power and coal industries.

Biomass is a renewable energy source that is made primarily of biological material. Examples of biomass include wood and yard clippings.

### SUMMARY OF THE INVENTION

Systems for producing power are presented. The system can include one or more gasifiers, such as low pressure gasifiers. For example, a gasifier from Shandong Yisheng Environmental Protection Equipment Company, Ltd., of Zibo, Shandong, China can be used.

The gasifiers can be arranged in series with one another or in parallel with one or another. The gasifiers can receive a stock fuel or feedstock, such as biomass, coal, or combinations thereof. The feedstock can have kcal's ranging from 3000 kcal/kg to 8000 kcal/kg. In some embodiments, a wet coal having from about 10 to about 55 wt % water can be used as the feedstock. In one or more embodiments, the feedstock can be coal that is pre-treated, and can have an energy value of from about 3000 kcal/kg to about 8000 kcal/kg.

The gasifier can receive a low pressure air stream. The low pressure air stream can have a pressure from about 1 atmosphere to about 3 atmospheres. The low pressure air stream can be an air stream at atmospheric pressure. The low pressure air stream is also referred to herein as an “unprepared air stream”.

The system can be configured to produce from about 30 megawatts to about 500 megawatts of power using synthetic methane gas created by the one or more gasifiers.

The synthetic methane gas produced by the system at a temperature ranging from about 120° C. to 600° C. can have a concentration of methane that can range from about 0.01 percent to about 10 percent of the gas stream. The synthetic methane gas can include hydrogen, carbon, methane, nitrogen, or combinations thereof.

One or more of the gasifiers can be in fluid communication with one or more gas clean up units. For example, a first gasifier can be in fluid communication with a first gas clean up unit. A second gasifier, in parallel to the first gasifier, can be in fluid communication with a second gas clean up unit, which can be in parallel or series with the first gas clean up unit. In another example, the first gasifier and the second gasifier can be in fluid communication with a one or more series connected gas clean up units. Each gas clean up unit can be configured to receive the synthetic methane gas, remove tar and sulfur therefrom, and cool the synthetic methane gas. In one or more embodiments, the gas clean up can also remove mercury. For example, the gas clean up can be include a catalyst for removing mercury.

In embodiments, each gas clean up unit can include one or more electrostatic precipitators, one or more heat exchangers, and one or more sulfur removal units.

The electrostatic precipitators can remove tar and particulates from the synthetic methane gas. Illustrative electrostatic precipitators can be manufactured by Shandong Yisheng Environmental Protection Equipment Company, Ltd., of Zibo, Shandong, China; one made from Bell Tran and known as the “wet tubular” electrostatic precipitator, or other electrostatic precipitators.

The heat exchanger can be a fin/fan heat exchanger, a concentric tube heat exchanger, a shell and tube heat exchanger, or other heat exchangers. The gas clean up unit can be operated at a pressure of about 1 atmosphere to about 3 atmospheres.

A recycle stream, such as a recycle liquid stream, can be created by the heat exchanger. The recycle stream can be communicated to one or more gasifiers via one or more recycle loops. The recycle stream can include water and phenols, other contaminates, or combinations thereof.

The sulfur removal unit can include a catalyst for facilitating the removal of sulfur from the synthetic methane gas. For example, the sulfur removal unit can be configured to perform a Claus process or other process to extract elemental sulfur from the synthetic methane gas. A Claus system can use thermal and catalytic reactions to extract the elemental sulfur from synthetic methane gas. Illustrative catalysts can include a cobalt based catalyst, iron based catalyst, ruthenium based catalyst, nickel based catalyst, or combinations thereof. Other illustrative catalysts include a catalyst product number 888 and a sulfur removal catalyst made by Dongshi™, of Jinan, Shandong, China.

The gas clean up unit can form a cooled synthetic methane gas at about 40° C. The cooled synthetic methane gas can be provided to a compressor. The cooled synthetic methane gas can be compressed to a usable pressure for combustion in a power system, forming a compressed synthetic methane gas.

The compressed synthetic methane gas can be provided to a gas turbine combustion system. The compressed synthetic methane gas can be at a pressure of from about 1 bar to about 35 bars.

The gas turbine combustion system can combust the compressed synthetic methane gas, producing exhaust gas and power. In one or more embodiments, the gas turbine combustion system can be a low heat value gas combustion system, such as those having a heat value between of at least 1200 kcal/nm̂3.

The power can be provided to an end user. The exhaust gas can be provided to a heat recovery steam generator. The heat recovery steam generator can generate steam.

A portion or all of the steam can be provided to a steam turbine. The steam turbine can expand the steam and generate additional power. In one or more embodiments, a portion of the steam can be provided to the steam turbine for generating additional energy, and another portion of the steam can be provided as process heat to a facility. The steam provided to the facility can be at a pressure of about 140 psi to about 2400 psi. The steam can be at a temperature of about 300 degrees Fahrenheit to about 1000 degrees Fahrenheit.

Methods for generating power using synthetic methane gas generated by low pressure gasification of a stock fuel are also presented.

Methods for small scale power generation, such as the generation of a net total power of less than 50 mega watts, are also presented. The generated power can be provided to an end user, such as to a power grid.

Methods for generating power using synthetic methane gas generated by low pressure gasification of a stock fuel, and concurrently generating one or more commercially marketable products, are also presented. The commercially marketable products can include tar, sulfur, particulates, mercury, and other products.

In some embodiments, the method can include gasifying a feedstock. The feedstock may be gasified using a low pressure air stream to generate a synthetic methane gas. For example, one or more gasifiers can be used to gasify the feedstock. The feedstock can include coal, biomass, or combinations thereof.

The method can include cleaning the synthetic methane gas, which can generate one or more commercially marketable byproducts. Cleaning the synthetic methane gas can include removing tar from the synthetic methane gas. For example, the synthetic methane gas can flow from the one or more gasifiers to one or more gas cleanup units. The gas cleanup units can clean the synthetic methane gas, such as by extracting or removing tar, particulate, and sulfur from the synthetic methane gas. The tar can be a first marketable byproduct. For example, the tar can be used for refined oil products, and as a base for asphalt. The sulfur removed or extracted can be from 90% to 99% pure elemental sulfur. The sulfur can be commercially marketable to the medical industry, the chemical industry, the refining industry, and other industries. As such, the sulfur can be a second marketable byproduct and can be used for industrial or medical purposes.

The cleaning of the synthetic methane gas can also include cooling the synthetic methane gas and removing moisture and phenols therefrom. At least a portion of the removed moisture and the phenols can be used to gasify the feedstock. For example, the phenols can be treated and reinjected into the gasifier for heating value and utilization.

The method can include compressing the cleaned synthetic methane gas. In one or more embodiments, the cleaned synthetic methane gas can compress to a pressure of at least about 20 bar. For example, the cleaned synthetic methane gas can flow from the one or more gas cleanup units to one or more compressors, which can compress the cleaned synthetic methane gas.

The method can include burning the compressed synthetic methane gas, such as in a gas turbine to generate power. For example, the compressed synthetic methane gas can flow from the one or more compressors to the gas turbine or gas turbine combustion system, which can burn the compressed synthetic methane gas.

The burning of the compressed synthetic methane gas can produce an exhaust gas, exhaust heat, and power. The method can include capturing exhaust heat and/or exhaust gas from the burning compressed synthetic methane gas. For example, the exhaust heat and/or exhaust gas can be captured suing a heat recovery steam generator. The heat recovery steam generator can use the exhaust heat and/or exhaust gas to generate or create steam.

The method can include expanding the created steam to generate additional power. For example, the generated steam can flow from the heat recovery steam generator to a steam turbine, which can receive the steam and use the steam to generate additional power. The net total power generated can be less than fifty megawatts. The method can include providing the generated power to an end user such as a power grid.

The method can include using an additional gas firing between the heat recovery steam generator and the gas turbine. As such, this increases the heat input to the Heat Recovery Steam Generator (“HRSG”) and produce more steam.

The method can include using a plurality of low pressure gasifiers to gasify the feedstock.

One or more embodiments can include producing a start up steam using a start up boiler, and flowing the start up steam to the plurality of low pressure gasifiers.

The method can include using the steam turbine to generate a process steam for use in an adjacent facility requiring steam.

One or more embodiments of the method can be carried out using one or more embodiments of a system disclosed herein.

The system can include one or more gasifiers, such as low pressure gasifiers. For example, a gasifier from Shandong Yisheng Environmental Protection Equipment Company, Ltd., of Zibo, Shandong, China can be used.

The gasifiers can be in series with one another or in parallel with one or another. The gasifiers can receive a stock fuel or feedstock, such as biomass, coal, or combinations thereof. The feedstock can have kcal's ranging from 3000 kcal/kg to 8000 kcal/kg. In one or more embodiments, a wet coal having from about 10 to about 55 wt % water can be used as the feedstock. In one or more embodiments, the feedstock can be coal that is pre-treated, and can have an energy value of from about 3000 kcal/kg to about 8000 kcal/kg.

The gasifier can receive a low pressure air stream. The low pressure air stream can have a pressure from about 1 atmosphere to about 3 atmospheres. The low pressure air stream can be an air stream at atmospheric pressure. The low pressure air stream is also referred to herein as an “unprepared air stream”.

The system can be configured to produce from about 30 megawatts to about 500 megawatts of power using synthetic methane gas created by the one or more gasifiers.

The synthetic methane gas produced by the system can have a concentration of methane that can range from about 0.01 percent to about 10 percent of the gas stream. The synthetic methane gas can include hydrogen, carbon, methane, nitrogen, or combinations thereof.

One or more of the gasifiers can be in fluid communication with one or more gas clean up units. For example, a first gasifier can be in fluid communication with a first gas clean up unit. A second gasifier, in parallel to the first gasifier, can be in fluid communication with a second gas clean up unit, which can be in parallel or series with the first gas clean up unit. In another example, the first gasifier and the second gasifier can be in fluid communication with a one or more series connected gas clean up units. Each gas clean up unit can be configured to receive the synthetic methane gas, remove tar and sulfur therefrom, and cool the synthetic methane gas. In one or more embodiments, the gas clean up can also remove mercury from the synthetic methane gas. For example, the gas clean up can be include a mercury removal device with a catalyst for removing mercury from the synthetic methane gas.

In one or more embodiments, cleaning the synthetic methane gas can include using an electrostatic precipitator system configured to remove the tar from the synthetic methane gas, and using a heat exchanger configured to cool the synthetic methane gas and produce a recycle stream.

In some embodiments, each gas clean up unit can include one or more electrostatic precipitators, one or more heat exchangers, and one or more sulfur removal units.

The electrostatic precipitators can remove tar and particulates from the synthetic methane gas. Illustrative electrostatic precipitators can be manufactured by Shandong Yisheng Environmental Protection Equipment Company, Ltd., of Zibo, Shandong, China; one made from Bell Tran and known as the “wet tubular” electrostatic precipitator, or other electrostatic precipitators.

The heat exchanger can be a fin/fan heat exchanger, a concentric tube heat exchanger, a shell and tube heat exchanger, or other heat exchangers. The gas clean up unit can be operated at a pressure of about 1 atmosphere to about 3 atmospheres.

A recycle stream, such as a recycle liquid stream, can be created by the heat exchanger. The recycle stream can be communicated to one or more gasifiers via one or more recycle loops. The recycle stream can include water and phenols, other contaminates, or combinations thereof.

The sulfur removal unit can include a catalyst for facilitating the removal of sulfur from the synthetic methane gas. For example, the sulfur removal unit can be configured to perform a Claus process or other process to extract elemental sulfur from the synthetic methane gas. A Claus system can use thermal and catalytic reactions to extract the elemental sulfur from synthetic methane gas. Illustrative catalysts can include a cobalt based catalyst, iron based catalyst, ruthenium based catalyst, nickel based catalyst, or combinations thereof. Other illustrative catalysts include a catalyst product number 888 and a sulfur removal catalyst made by Dongshi™, of Jinan, Shandong, China.

The gas clean up unit can form a cooled synthetic methane gas. The cooled synthetic methane gas can be provided to a compressor. The cooled synthetic methane gas can be compressed to a usable pressure for combustion in a power system, forming a compressed synthetic methane gas.

The compressed synthetic methane gas can be provided to a gas turbine combustion system. The compressed synthetic methane gas can be at a pressure of from about 1 bar to about 35 bars.

The gas turbine combustion system can combust the compressed synthetic methane gas, producing exhaust gas and power. In one or more embodiments, the gas turbine combustion system can be a low heat value gas combustion system, such as those having a heat value between of at least 1200 kcal/nm̂3.

The power can be provided to an end user. The exhaust gas can be provided to a heat recovery steam generator. The heat recovery steam generator can generate steam.

A portion or all of the steam can be provided to a steam turbine. The steam turbine can expand the steam and generate additional power. In one or more embodiments, a portion of the steam can be provided to the steam turbine for generating additional energy, and another portion of the steam can be provided as process heat to a facility. The steam provided to the facility can be at a pressure of from about 140 psi to about 2400 psi. The steam can be at a temperature of about 300 degrees Fahrenheit to about 1000 degrees Fahrenheit.

In one or more embodiments, duct firing can be provided between the turbine combustion system and the heat recovery steam generator. The duct firing can receive synthetic methane gas from one or more of the gasifiers. As such, the exhaust gas can be heated even further, allowing the heat recovery steam generator to generate more steam.

In one or more embodiments, the system for power generation using low pressure gasification of a feedstock can include twenty-four gasifiers, six gas clean up units connected to the twenty-four gasifiers, two gas compressors connected to the six gas clean up units, two gas turbine combustions systems connected to the two gas compressors, and two heat recovery steam generators connected to the two gas turbine combustion systems.

In one embodiments, the system can include a plurality of compressors in series, parallel, or combinations thereof with one another, a plurality gas clean up units in series, parallel, or combinations thereof with one another, a plurality gas turbine combustion systems in series, parallel, or combinations thereof with one another, a plurality of heat recovery systems in series, parallel, or combinations thereof with one another, and a plurality of steam turbines in series, parallel, or combinations thereof with one another.

In one or more embodiments, the system for power generation using low pressure gasification of a feedstock can include twenty-four gasifiers, six gas clean up units connected to the twenty-four gasifiers, two gas compressors connected to the six gas clean up units, two gas turbine combustions systems connected to the two gas compressors, and two heat recovery steam generators connected to the two gas turbine combustion systems.

In one embodiments, the system can include a plurality of compressors in series, parallel, or combinations thereof with one another, a plurality gas clean up units in series, parallel, or combinations thereof with one another, a plurality gas turbine combustion systems in series, parallel, or combinations thereof with one another, a plurality of heat recovery systems in series, parallel, or combinations thereof with one another, and a plurality of steam turbines in series, parallel, or combinations thereof with one another.

The term “coupled” is defined as connected, although not necessarily directly, and not necessarily mechanically.

The terms “a” and “an” are defined as one or more unless this disclosure explicitly requires otherwise.

The term “substantially” and its variations are defined as being largely, but not necessarily wholly, what is specified as understood by one of ordinary skill in the art, and in one non-limiting embodiment “substantially” refers to ranges within 10%, preferably within 5%, more preferably within 1%, and most preferably within 0.5% of what is specified.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or device that “comprises,” “has,” “includes” or “contains” one or more steps or elements possesses those one or more steps or elements, but is not limited to possessing only those one or more elements. For example, an antenna may have a resonator, and in some cases, may also have vertical slits Likewise, a step of a method or an element of a device that “comprises,” “has,” “includes” or “contains” one or more features possesses those one or more features, but is not limited to possessing only those one or more features. Furthermore, a device or structure that is configured in a certain way is configured in at least that way, but may also be configured in ways that are not listed.

Other features and associated advantages will become apparent with reference to the following detailed description of specific embodiments in connection with the accompanying drawings.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1 depicts a schematic of a system according to one or more embodiments.

FIG. 2 depicts the system with an additional duct firing system and a facility in communication with a heat recovery steam generator according to one or more embodiments.

FIG. 3 depicts an embodiment of a gas clean-up unit according to one or more embodiments.

FIG. 4 depicts a flow diagram of one or more embodiments of the methods.

FIG. 5 depicts a flow diagram of one or more embodiments of the methods.

The present embodiments are detailed below with reference to the listed Figures.

### DETAILED DESCRIPTION OF THE EMBODIMENTS

Various features and advantageous details are explained more fully with reference to the non-limiting embodiments that are illustrated in the accompanying drawings and detailed in the following description. Descriptions of well known starting materials, processing techniques, components, and equipment are omitted so as not to unnecessarily obscure the invention in detail. It should be understood, however, that the detailed description and the specific examples, while indicating embodiments of the invention, are given by way of illustration only, and not by way of limitation. Various substitutions, modifications, additions, and/or rearrangements within the spirit and/or scope of the underlying inventive concept will become apparent to those skilled in the art from this disclosure.

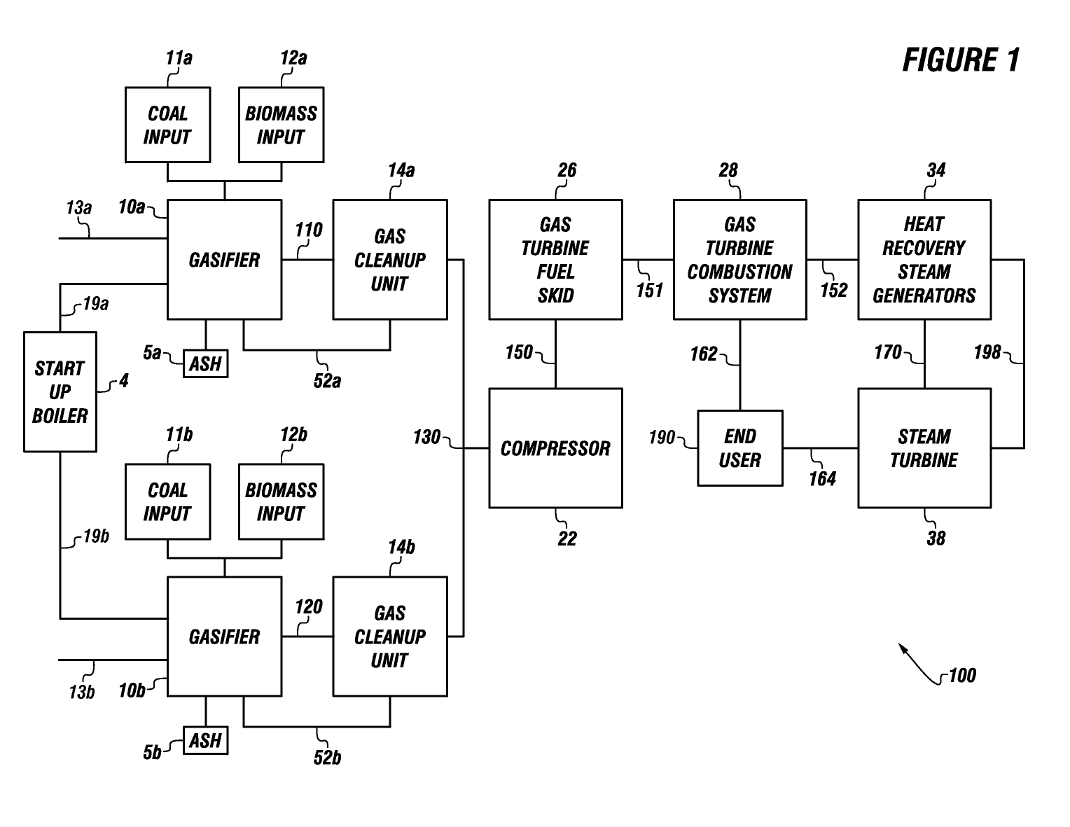

FIG. 1 depicts a schematic of a system 100 according to one or more embodiments. The system 100 can include one or more gasifiers (two are shown 10a and 10b), one or more coal inputs (two are shown 11a and 11b), one or more biomass inputs (two are shown 12a and 12b), one or more gas clean up units (two are shown 14a and 14b), one or more recycle loops (two are shown 52a and 52b), one or more compressors 22, one or more gas turbine combustion systems 28, one or more heat recovery steam generators 34, and one or more steam turbines 38.

The first gasifier 10a is configured to receive feedstock through the first biomass input 12a, the first coal input 11a, or combinations thereof. The second gasifier 10b is configured to receive feedstock through the second biomass input 12b, the first coal input 11b, or combinations thereof. A first low pressure air stream 13a can be provided to the first gasifier 10a, and a second low pressure air stream 13b, can be provided to the second gasifier 10b. The low pressure streams 13a and 13b, can have a pressure from about 1 atmosphere to about 3 atmospheres (atm). The low pressure streams used with gasifiers 10a and 10b may result in cheaper power generation compared to higher pressure systems. In addition, low pressure systems may increase reliability. For example, a typical power generator using low pressure systems may have a larger number of gasifier units than a high-pressure system. As such, the larger number of units may increase the reliability of the system by adding redundancy to the system. In addition, the low pressure may increase the safety of the system as a whole.

The first gasifier 10a can receive start up steam via flow path 19a, and the second gasifier 10b can receive start up steam via flow path 19b. The start up steams can be produced by one or more start steam generating devices, such as start up boiler 4.

The gasifiers 10a and 10b can independently provide synthetic methane gas generated in the gasifiers via flow paths 110 and 120 respectively to the gas clean up units 14a and 14b. The synthetic methane gas may be at a low pressure, due to the low pressure gasifiers. The clean up units 14a and 14b may be configured to clean the synthetic methane gas at the low pressure, which may lower the cost of cleaning the gas compared to high pressure clean up units. The gasifiers 10a and 10b can receive a recycle stream via flow paths 52a and 52b respectively, which can be recycle loops.

The gasifiers 10a and 10b can produce ash 5a and 5b respectively.

The gas clean up units 14a and 14b can remove tar, particulates, and sulfur from the synthetic methane gas, and can cool the synthetic methane gas. The tar can be sold as a commercial product. The particulates can be recycled back into the system or stored. The sulfur can be up to 99 percent elemental and can be sold as a commercial product. The heat exchanger in the gas clean up system, reduces the temperature of the synthetic methane gas to at least 40 C prior to entering the sulfur and/or mercury catalyst.

In some embodiments, low pressure gasification for power generation may simplify the gas cleanup process, may reduce cost, and may be safer than higher pressure systems. Higher pressure gasification processes for power generation typically pressurize input gas (either air or oxygen) to above 30 atmospheres for gasification. The high pressure may complicate gas cleanup and may reduce safety.

The cooled synthetic methane gas can be provided to the compressor 22 via flow path 130. The compressor 22 can compress the cooled synthetic methane gas and the compressed cooled synthetic methane gas can flow to one or more gas turbine fuel skids 26 via flow path 150. The gas turbine fuel skid 26 can be located on or proximate to the gas turbine combustion system 28. The gas turbine fuel skid 26 can control the flow of compressed cooled methane gas, via flow path 151, to the gas turbine combustion system 28.

The compressed cooled synthetic methane gas can be provided to the gas turbine combustion system 28. The gas turbine combustion system 28 can combust the compressed cooled synthetic methane gas to generate an exhaust gas and power. The power can be transferred from the system via line 162, such as a power line, to an end user 190. The exhaust gas can be provided to the heat recovery steam generators 34 via flow path 152.

The heat recovery steam generators 34 can exchange heat with the exhaust gas and provide steam. The steam can be provided to the steam turbine 38 via flow path 170.

The steam turbine 38 can expand the steam to produce additional power, which can be removed from the system via line 164 and provided to the end user 190. When the steam is expanded, a condensate can be formed. The condensate can be transferred back the heat recovery steam generators 34 via flow path 198.

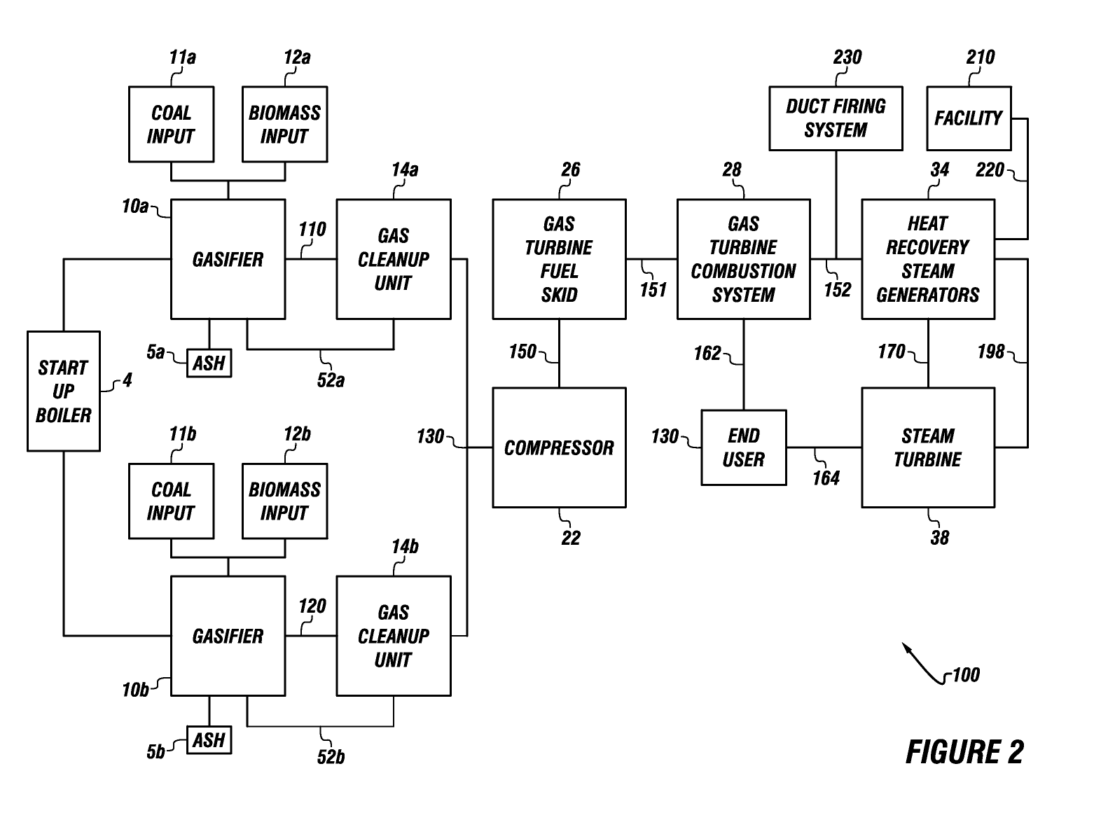

FIG. 2 depicts the system 100 with a duct firing system 230 and a facility 210 in communication with the heat recovery steam generators 34 according to one or more embodiments. Steam is provided to the steam turbine via flowpath 170. A portion of the steam expanded in the steam turbine 38, can be extracted and transported to a facility 210, via flowpath 220, The facility 210 can be a refinery, a chemical plant, a paper mill, municipal water heat supply, or other operations requiring process heat.

In addition, the duct firing system 230 can be disposed between the gas turbine combustion system 28 and the heat recovery steam generators 34. The duct firing system 230 can receive synthetic methane gas from the first gasifier 10a, the second gasifier 10b, an additional gasifier, or combinations thereof. The duct firing system 230 can combust the received synthetic methane gas and provide additional heat to the exhaust gas in the flow path 152.

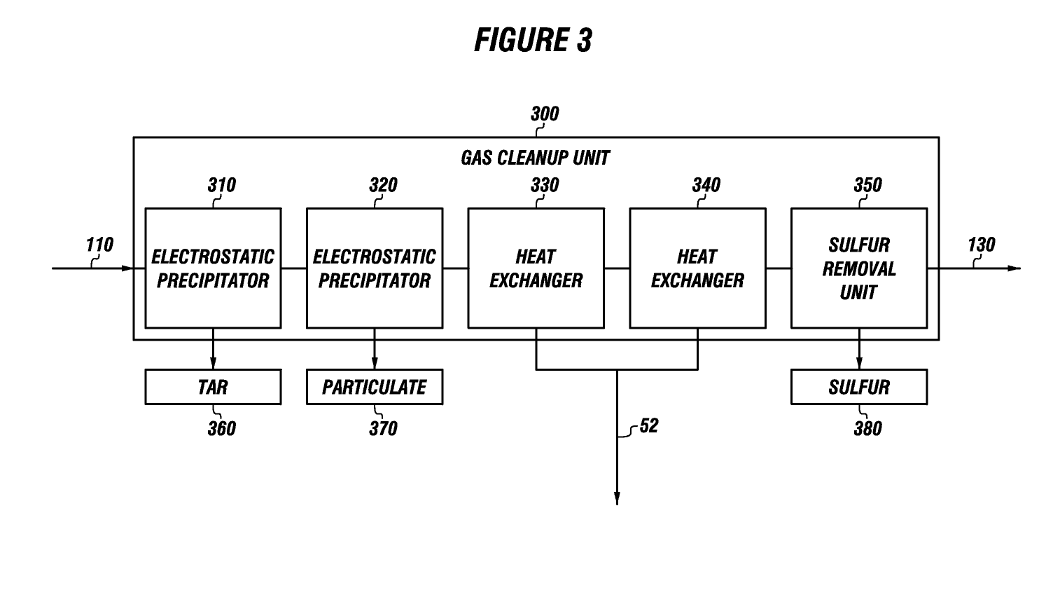

FIG. 3 depicts an embodiment of a gas clean up unit 300 according to one or more embodiments. The gas clean up units 14a and 14b shown in FIGS. 1 and 2 can be substantially similar to the gas clean up unit 300 shown in FIG. 3. The gas clean up unit 300 can include one or more electrical static precipitators (two are shown 310 and 320), one or more heat exchangers (two are shown 330 and 340), and one or more sulfur removal units 350.

The first electric static precipitator 310 can be in series with the second electric static precipitator 320. The gas clean up unit 300 can receive synthetic methane gas from flow path 110. The first electric static precipitator 310 can be used to remove tar 360 from the synthetic methane gas. The second electric static precipitator 320 can be used to remove other particulate 370 from the synthetic methane gas. The heat exchangers 330 and 340 can transfer heat from the synthetic methane gas to a cooling medium, and the cooling medium can be cycled back to one or more gasifiers as a recycle stream 52.

The sulfur removal unit 350 can have one or more catalysts configured to remove sulfur 380 in elemental form from the synthetic methane gas. The elemental sulfur can be 99% pure. The cooled synthetic methane gas can be removed from the gas clean up unit via flow path 130.

While these embodiments have been described with emphasis on the embodiments, it should be understood that within the scope of the appended claims, the embodiments might be practiced other than as specifically described herein.

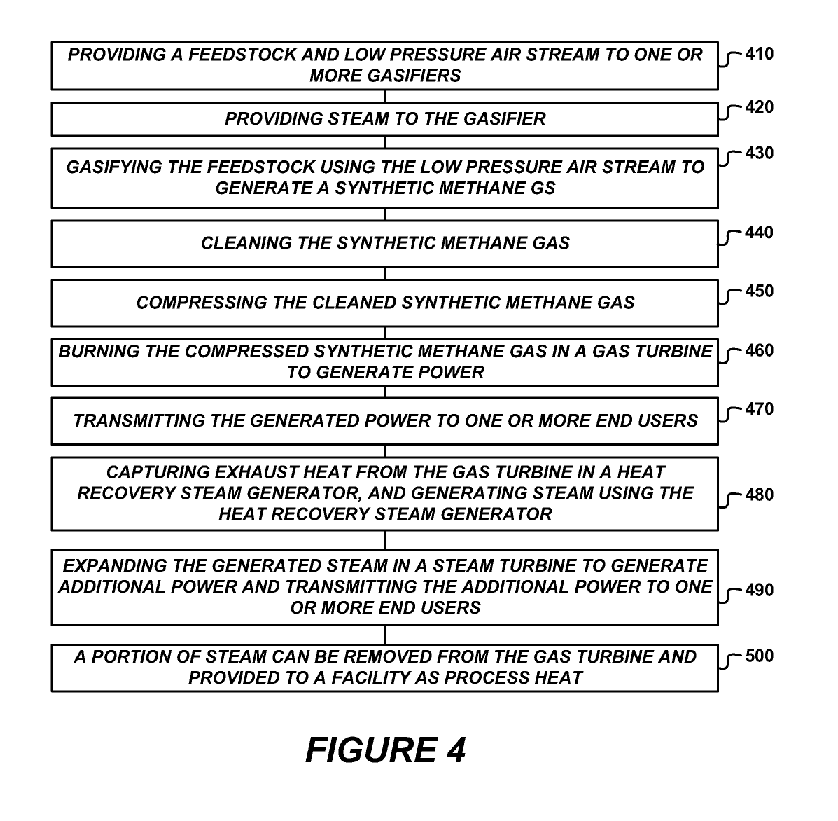

FIG. 4 depicts an embodiment of a method for generating power using synthetic methane gas generated by low pressure gasification of a stock fuel.

The method for generating power using synthetic methane gas generated by low pressure gasification of a stock fuel can include providing a feedstock and low pressure air stream to one or more gasifiers, as depicted in box 410. The feedstock can be coal, biomass, or combinations thereof.

In addition, the method can include providing steam to the gasifier, as depicted in box 420. For example, the steam can be provided during the start up of the gasifier as start up steam. The steam can be provided by a boiler.

The method can also include gasifying the feedstock using the low pressure air stream to generate a synthetic methane gas, as depicted in box 430.

The method can continue by cleaning the synthetic methane gas, as depicted in box 440. The synthetic methane gas can be cleaned by removing tar, sulfur, mercury, and other contaminates.

The removed tar from the synthetic methane gas can be used as a first marketable product. For example, the tar can be sold to refineries for generating oil products. The tar can be used to create asphalt for road repairs. The sulfur can be removed as a second marketable product. For example, the sulfur can be used for industrial or medical purposes.

The cleaning of the synthetic methane gas can also include cooling the synthetic methane gas. When the synthetic methane gas is cooled, moisture and phenols can be extracted from the synthetic methane gas. At least a portion of the removed moisture and the phenols can be provided back to aid in the gasification of the feedstock.

In one or more embodiments, cleaning the synthetic methane gas can include using an electrostatic precipitator system configured to remove the tar from the synthetic methane gas; using a heat exchanger configured to cool the synthetic methane gas and produce a recycle stream; and using a sulfur removal unit to remove sulfur from the synthetic methane.

After the synthetic methane gas is cleaned, the method can include compressing the cleaned synthetic methane gas, as depicted in box 450.

The compressed synthetic methane gas can be provide down stream, and the method can include burning the compressed synthetic methane gas in a gas turbine to generate power, as depicted in box 460. The gas turbine can be in communication with or include a low heat value gas combustion system.

The method can also include transmitting the generated power to one or more end users as depicted in box 470. The transmission of power can include the use of capacitors, power lines, energy storage devices, municipal grids, or combinations thereof.

The method can further include, capturing exhaust heat from the gas turbine in a heat recovery steam generator, and generating steam using the heat recovery generator, as depicted in box 480.

The method can continue by expanding the generated steam in a steam turbine to generate additional power and transmitting the additional power to one or more end users, as depicted 490. The transmission can be similar to method described herein or the like.

A portion of steam can be removed from the gas turbine and provide to a facility as process heat, as depicted in box 500. Another portion of the steam from the gas turbine can be condensed and cycled back to the heat recovery steam generator and used to generate steam therein.

In one or more embodiments, the method can also include additional duct firing between the heat recovery steam generator and the gas turbine. The additional duct firing can be done using the synthetic methane gas generated by the gasifier or from another gasifier.

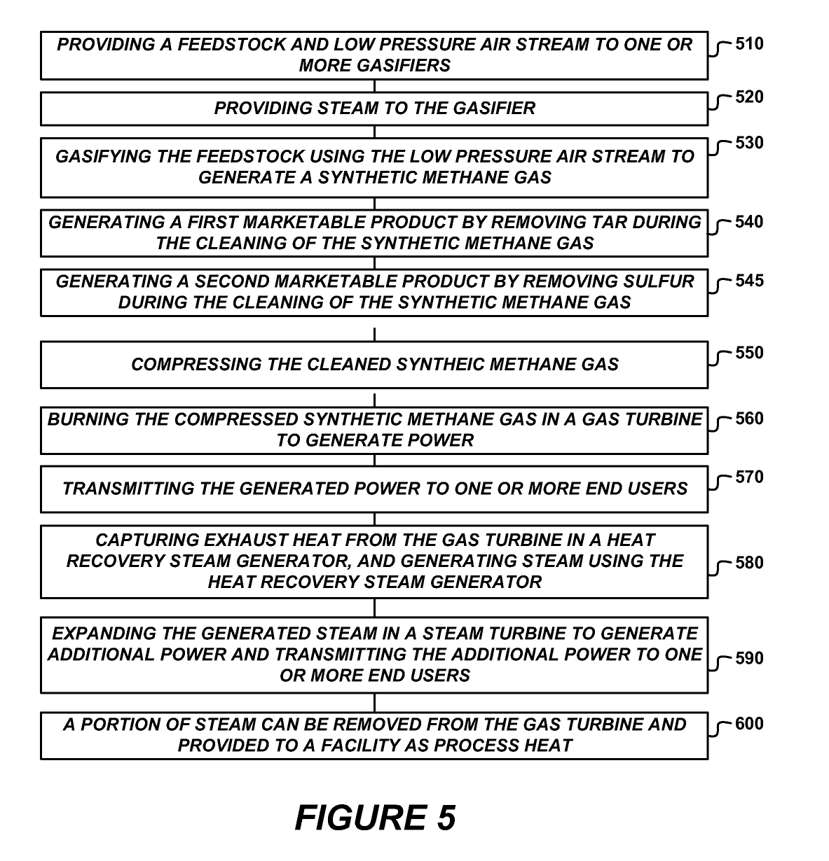

FIG. 5 depicts an embodiment of a method for generating power using synthetic methane gas generated by low pressure gasification of a stock fuel.

A method for generating power using synthetic methane gas generated by low pressure gasification of a stock fuel can include providing a feedstock and low pressure air stream to one or more gasifiers, as depicted in box 510. The feedstock can be coal, biomass, or combinations thereof.

In addition, the method can include providing steam to the gasifier, as depicted in box 520. for example, the steam can be provided during the start up of the gasifier as start up steam. The steam can be provided by a boiler.

The method can also include gasifying the feedstock using the low pressure air stream to generate a synthetic methane gas, as depicted in box 530.

The method can continue by generating a first marketable product by removing tar during the cleaning of the synthetic methane gas, as depicted in box 540. The method can also include generating a second marketable product during the cleaning of the synthetic methane gas by removing sulfur, as depicted in box 545. The cleaning of the synthetic methane gas can also include removing mercury and other contaminates therefrom. The tar can be sold to refineries for generating oil products. Or the tar can be used to create asphalt for road repairs. The sulfur can be can be used for medical or industrial uses.

The cleaning of the synthetic methane gas can also include cooling the synthetic methane gas. When the synthetic methane gas is cooled, moisture and phenols can be extracted from the synthetic methane gas. At least a portion of the removed moisture and the phenols can be provided back to aid in the gasification of the feedstock.

In one or more embodiments, cleaning the synthetic methane gas can include using an electrostatic precipitator system configured to remove the tar from the synthetic methane gas; using a heat exchanger configured to cool the synthetic methane gas and produce a recycle stream, and using a sulfur removal unit to remove sulfur from the synthetic methane.

After the synthetic methane gas is cleaned, the method can include compressing the cleaned synthetic methane gas, as depicted in box 550. The compressed synthetic methane gas can be provided down stream, and the method can include burning the compressed synthetic methane gas in a gas turbine to generate power, as depicted in box 560. The gas turbine can be in communication with or include a low heat value gas combustion system.

The method can also include transmitting the generated power to one or more end users as depicted in box 570. The transmission of power can include the use of capacitors, power lines, energy storage devices, municipal grids, or combinations thereof.

The method can further include, capturing exhaust heat from the gas turbine in a heat recovery steam generator, and generating steam using the heat recovery steam generator, as depicted in box 580.

The method can continue by expanding the generated steam in a steam turbine to generate additional power and transmitting the additional power to one or more end users, as depicted in box 590. The transmission can be similar to method described herein or the like.

A portion of steam can be removed from the gas turbine and provide to a facility as process heat, as depicted in box 600. Another portion of the steam from the gas turbine can be condensed and cycled back to the heat recovery steam generator and used to generate steam therein.

In one or more embodiments, the method can also include additional duct firing between the heat recovery steam generator and the gas turbine. The additional duct firing can be done using the synthetic methane gas generated by the gasifier or from another gasifier.

What is claimed is:

1. A system for power generation using low pressure gasification of a stock fuel, wherein the system comprises:
a. a gasifier operated using a low pressure air stream, wherein the gasifier is configured to provide a synthetic methane gas;
b. a gas clean up unit configured to receive the synthetic methane gas, wherein the gas clean up unit is configured to remove tars and sulfur from the synthetic methane gas and cool the synthetic methane gas provided by the gasifier;
c. a gas compressor configured to receive cooled synthetic methane gas from the gas clean up unit and compress the cooled synthetic methane gas;
d. a gas turbine combustion system configured to receive the compressed synthetic methane gas and produce power and an exhaust gas;
e. a heat recovery steam generator to receive the exhaust gas and generate steam;
and
f. a steam turbine for receiving the steam from the heat recovery steam generator and generating power.

2. The system of claim 1, wherein the gas turbine combustion system comprises a low heat value gas combustion system.

3. The system of claim 1, wherein the low pressure air stream is an unprepared air stream.

4. The system of claim 1, wherein the stock fuel comprises coal or biomass.

5. The system of claim 1, wherein the compressed synthetic methane gas is at a pressure of at least twenty bars.

6. The system of claim 1, wherein the gas clean up unit comprises:
a. an electrostatic precipitator system configured to remove from the synthetic methane gas: tar, particulates, or combinations thereof;
b. a heat exchanger configured to cool the synthetic methane gas and produce a recycle stream;
c. a recycle loop in fluid communication with the heat exchanger and the gasifier; and
d. a sulfur removal unit.

7. The system of claim 6, wherein the sulfur removal unit comprises a catalyst.

8. The system of claim 6, wherein the recycle stream includes water and phenol.

9. The system of claim 1, further comprising a plurality of gasifiers connected in parallel.

10. The system of claim 9, further comprising a gas clean up unit connected to each gasifier.

11. The system of claim 10, further comprising a gas compressor connected to each clean up unit.

12. The system of claim 11, further comprising a gas turbine combustion system connected to each gas compressor.

13. The system of claim 12, further comprising a heat recovery steam generator connected to an exhaust of each gas turbine combustion system.

14. The system of claim 9, further comprising a start up boiler for producing start up steam that is flowed to the plurality of gasifiers.

15. A method for generating power, the method comprising:
a. gasifying a feedstock using a low pressure air stream to generate a synthetic methane gas;
b. cleaning the synthetic methane gas;
c. compressing the cleaned synthetic methane gas;
d. burning the compressed synthetic methane gas in a gas turbine to generate power;
e. capturing exhaust heat from the gas turbine in a heat recovery steam generator, and generating steam using the heat recovery generator; and
f. expanding the generated steam in a steam turbine to generate additional power.

16. The method of claim 15, further comprising generating a commercially marketable byproduct.

17. The method of claim 16, wherein cleaning the synthetic methane gas comprises removing tar from the synthetic methane gas, and wherein the tar is a first marketable byproduct.

18. The method of claim 16, wherein cleaning the synthetic methane gas comprises extracting sulfur from the synthetic methane gas, and wherein the sulfur is a second marketable product.

19. The method of claim 18, wherein the sulfur is from 90 percent to 99 percent pure elemental sulfur.

20. The method of claim 18, further comprising generating a third marketable product, wherein the third marketable product is mercury.

21. The method of claim 15, wherein cleaning the synthetic methane gas further comprises cooling the synthetic methane gas and removing moisture and phenols from the synthetic methane gas.

22. The method of claim 21, further comprising providing at least a portion of the removed moisture and the phenols to the gasifier.

23. The method of claim 15, further comprising providing additional heat to the captured exhaust heat using additional duct firing between the heat recovery steam generator and the gas turbine.

24. The method of claim 15, wherein the feedstock comprises coal, biomass, or combinations thereof.

25. The method of claim 15, wherein the cleaned synthetic methane gas is compressed to a pressure of at least twenty bar.

26. The method of claim 15, further comprising using a plurality of low pressure gasifiers to gasify the feedstock.

27. The method of claim 15, further comprising producing a start up steam using a start up boiler, and flowing the start up steam to the plurality of low pressure gasifiers.

28. The method claim 15, wherein the gas turbine comprises a low heat value gas combustion system.

29. The method of claim 15, wherein cleaning the synthetic methane gas comprises:
a. using an electrostatic precipitator system configured to remove the tar from the synthetic methane gas;
b. using a heat exchanger configured to cool the synthetic methane gas and produce a recycle stream; and
c. using a sulfur removal unit to remove sulfur from the synthetic methane gas.

30. The method of claim 15, further comprising providing at least a portion of the net total power to an end user, and wherein a net total power generated is less than fifty megawatts.

31. The method of claim 30, further comprising using an unprepared air stream as the low pressure air stream.
